(19) United States
(12) Patent Application Publication
(10) Pub. No.: US 2024/0303900 A1
(43) Pub. Date: Sep. 12, 2024

(54) METHOD, APPARATUS AND SYSTEM FOR GRAPHICS RENDERING BASED ON WEBGL

(71) Applicant: GAODING (XIAMEN) TECHNOLOGY CO., LTD, Xiamen (CN)

(72) Inventors: Chen PAN, Xiamen (CN); Ze ZHENG, Xiamen (CN)

(73) Assignee: GAODING (XIAMEN) TECHNOLOGY CO., LTD, Xiamen (CN)

(21) Appl. No.: 18/578,740

(22) PCT Filed: Mar. 11, 2022
(86) PCT No.: PCT/CN2022/080390

§ 371 Date: Jan. 12, 2024

(30) Foreign Application Priority Data
Aug. 5, 2021 (CN) 2021108966104

(51) Int. Cl. G06T 15/00; G06T 15/80

(52) U.S. Cl. CPC G06T 15/005; G06T 15/80

(57) ABSTRACT

A method, an apparatus and a system for graphics rendering based on a Web Graphics Library (WebGL) are provided. The method includes that: initial rendering information is acquired; the initial rendering information is converted according to a preset layer encapsulation format to obtain layer rendering data; the layer rendering data is mapped into a WebGL data format to obtain WebGL rendering data; and a WebGL interface is invoked and rendering output is performed according to the WebGL rendering data. According to the method, an element drawn by the WebGL is encapsulated into a layer, the layer rendering data is acquired in a form of preset layer encapsulation format, and then the layer rendering data is mapped into the WebGL data format, so that the underlying drawing ability is opened to a web application layer.

### CROSS REFERENCE TO THE RELATED APPLICATIONS

This application is the national phase entry of International Application No. PCT/CN2022/080390, filed on Mar. 11, 2022, which is based upon and claims priority to Chinese Patent Application No. 202110896610.4, filed on Aug. 5, 2021, the entire contents of which are incorporated herein by reference.

### TECHNICAL FIELD

The application generally relates to the technical field of computers. More specifically, the application relates to a method, an apparatus and a system for graphics rendering based on a Web Graphics Library (WebGL).

### BACKGROUND

A WebGL is a technical standard for drawing, which combines Javascript and an Open Graphics Library (OpenGL) to open the underlying drawing ability to a web application layer, and this standard is widely supported on a browser platform.

However, the implementation of the WebGL is a state machine, drawing through the state machine requires maintaining various complicated states such as vertex coordinates and texture coordinates, and a little carelessness may lead to errors in rendering results, which makes it difficult to build a complex rendering system thereon.

Based on the above technical problem, the application is particularly proposed.

### SUMMARY

To at least partially solve the technical problem mentioned in the background, the solution of the application provides a method, an apparatus and a system for graphics rendering based on a WebGL.

According to a first aspect of the application, the application provides a method for graphics rendering based on a WebGL. The method may include that: initial rendering information is acquired; the initial rendering information is converted according to a preset layer encapsulation format to obtain layer rendering data; the layer rendering data is mapped into a WebGL data format to obtain WebGL rendering data; and a WebGL interface is invoked and rendering output is performed according to the WebGL rendering data. According to the application, an element drawn by the WebGL is encapsulated into a layer, the layer rendering data is acquired in a form of preset layer encapsulation format, and then the layer rendering data is mapped into the WebGL data format, so that the underlying drawing ability is opened to a web application layer. Herein, the preset layer encapsulation format may be provided to the web application layer through an interface.

Optionally, the initial rendering information includes to-be-rendered element data and a linear transformation instruction to be performed on the to-be-rendered element.

Optionally, the preset layer encapsulation format includes a preset data source format and a preset matrix format. The layer rendering data includes pixel data of the to-be-rendered element and transformation matrix data of the to-be-rendered element. The operation of converting the initial rendering information according to the preset layer encapsulation format to obtain the layer rendering data may include that: the to-be-rendered element data is converted according to the preset data source format to obtain the pixel data; and the linear transformation instruction is converted according to the preset matrix format to obtain the transformation matrix data.

Optionally, the operation of converting the to-be-rendered element data according to the preset data source format to obtain the pixel data may include that: the to-be-rendered element data is converted by setting a texture pixel and/or directly setting a frame buffer to obtain the pixel data.

Optionally, the operation of converting the linear transformation instruction according to the preset matrix format to obtain the transformation matrix data may include that: according to the linear transformation instruction and the corresponding preset matrix format, the linear transformation matrix corresponding to the linear transformation instruction is obtained, and then the initial matrix is multiplied by the corresponding linear transformation matrix in turn according to an order of the linear transformation instruction to obtain the transformation matrix data.

Optionally, the preset matrix format is preset according to the linear transformation instruction, and the same type of linear transformation instructions correspond to the same preset matrix format. The type of the linear transformation instruction includes any one of translation, rotation and scaling.

Optionally, the operation of mapping the layer rendering data into the WebGL data format to obtain the WebGL rendering data may include that: the pixel data is mapped into WebGL texture; and the transformation matrix data is mapped into an attribute in a WebGL shader.

Optionally, the initial rendering information includes global attribute data. The method may further include that: before the initial rendering information is converted according to the preset layer encapsulation format to obtain layer rendering data, WebGL context is set according to the global attribute data. The WebGL context includes data related to global attributes such as canvas width and height.

According to a second aspect of the application, the application provides a method for graphics rendering based on a WebGL. The method may include that: a first rendering element is obtained by adopting the method for graphics rendering based on the WebGL; whether to keep the first rendering element is judged; if not, the first rendering element is recycled; it is judged whether new initial rendering information exists; and if so, a second rendering element is obtained by adopting the method for graphics rendering based on the WebGL.

According to a third aspect of the application, the application provides an apparatus for graphics rendering based on a WebGL. The apparatus may include: an acquisition module, configured to acquire initial rendering information; a format conversion module, configured to convert the initial rendering information according to a preset layer encapsulation format to obtain layer rendering data; a data processing module, configured to map the layer rendering data into a WebGL data format to obtain WebGL rendering data; and a rendering module, configured to invoke a WebGL interface and perform rendering output according to the WebGL rendering data.

Optionally, the acquisition module is configured to acquire the following information: to-be-rendered element data and a linear transformation instruction to be performed on the to-be-rendered element.

Optionally, the preset layer encapsulation format includes a preset data source format and a preset matrix format. The layer rendering data includes pixel data of the to-be-rendered element and transformation matrix data of the to-be-rendered element. The format conversion module is configured to obtain the layer rendering data in the following manner: the to-be-rendered element data is converted according to the preset data source format to obtain the pixel data; and the linear transformation instruction is converted according to the preset matrix format to obtain the transformation matrix data.

Optionally, the format conversion module is configured to acquire the pixel data in the following manner: the to-be-rendered element data is converted by setting a texture pixel and/or directly setting a frame buffer to obtain the pixel data.

Optionally, the format conversion module is configured to obtain the transformation matrix data in the following manner: according to the linear transformation instruction and the corresponding preset matrix format, the linear transformation matrix corresponding to the linear transformation instruction is obtained, and then the initial matrix is multiplied by the corresponding linear transformation matrix in turn according to an order of the linear transformation instruction to obtain the transformation matrix data.

Optionally, the data processing module is configured to obtain the WebGL rendering data in the following manner: the pixel data is mapped into WebGL texture; and the transformation matrix data is mapped into an attribute in a WebGL shader.

Optionally, the initial rendering information includes global attribute data. The apparatus may further include a setting module, configured to set WebGL context according to the global attribute data.

According to a fourth aspect of the application, the application provides a system for graphics rendering based on a WebGL. The system may include the above-mentioned apparatus for graphics rendering based on the WebGL, configured to obtain a rendering element; a logic processing apparatus, configured to process a logic judgment; and a recycling apparatus, configured to recycle the rendering element according to an instruction of the logic processing apparatus.

Optionally, after a first rendering element is obtained by the apparatus for graphics rendering based on the WebGL, the logic processing apparatus is configured to process the following logic judgment: whether to keep the first rendering element is judged; if not, the recycling apparatus is instructed to recycle the first rendering element; it is judged whether new initial rendering information exists; and if so, the apparatus for graphics rendering based on the WebGL is instructed to obtain a second rendering element according to the new initial rendering information.

According to a fifth aspect of the application, the application provides an electronic apparatus. The apparatus may include a memory and a processor. The memory stores a computer program. When executing the computer program, the processor implements the method for graphics rendering based on the WebGL.

According to a sixth aspect of the application, the application provides a computer readable storage medium. The storage medium stores a computer program. When executed, the computer program implements the above-mentioned method for graphics rendering based on the WebGL in the application.

According to the method, the apparatus and the system for graphics rendering based on the WebGL in the application, the element drawn by the WebGL is encapsulated into the layer, the layer rendering data is acquired in the form of preset layer encapsulation format, and then the layer rendering data is mapped into the WebGL data format, so that the underlying drawing ability is opened to the web application layer. According to the method and apparatus for graphics rendering based on the WebGL, the understanding cost of the development of web application layer rendering is reduced, and it is no longer necessary to manually maintain various attributes in the state machine, but only to operate layer attributes intuitively, which is simple and easy to operate.

### BRIEF DESCRIPTION OF THE DRAWINGS

The above and other objects, features and advantages of exemplary implementations of the application will become easier to understand by reading the following detailed description with reference to the accompanying drawings. In the drawings, a plurality of implementations of the application are illustrated by way of example but not limitation, and the same or corresponding reference numerals indicate the same or corresponding parts.

FIG. 1 illustrates a schematic flowchart of a method for graphics rendering based on a WebGL according to an implementation of the application.

FIG. 2 illustrates a schematic flowchart of a method for graphics rendering based on a WebGL according to another implementation of the application.

FIG. 3 illustrates a schematic flowchart of a method for graphics rendering based on a WebGL according to a specific embodiment of the application.

FIG. 4 illustrates a schematic block diagram of an apparatus for graphics rendering based on a WebGL according to an implementation of the application.

FIG. 5 illustrates a schematic block diagram of a system for graphics rendering based on a WebGL according to another implementation of the application.

### DETAILED DESCRIPTION OF THE EMBODIMENTS

Clear and complete descriptions will be made on technical solutions in the embodiments of the application below in combination with drawings in the embodiments of the application. It is apparent that the described embodiments are a part rather than all of embodiments of the application. All other embodiments obtained by those skilled in the art based on the embodiments in the application without creative work shall fall within the scope of protection of the application.

Specific implementations of the application are described below in detail in combination with the accompanying drawings.

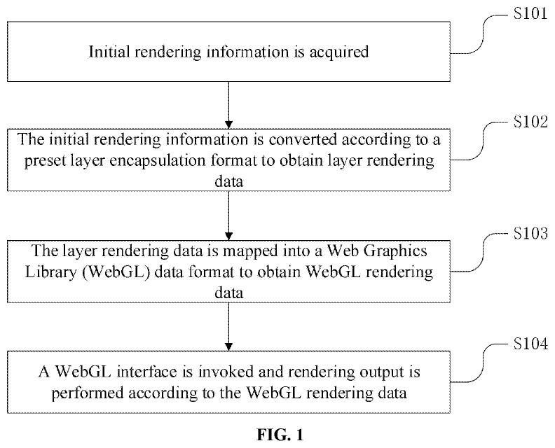

An implementation of the application provides a method for graphics rendering based on a WebGL. As shown in FIG. 1, the method includes the following steps of S101-S104. At S101, initial rendering information is acquired. At S102, the initial rendering information is converted according to a preset layer encapsulation format to obtain layer rendering data. At S103, the layer rendering data is mapped into a WebGL data format to obtain WebGL rendering data. At S104, a WebGL interface is invoked and rendering output is performed according to the WebGL rendering data.

According to the application, an element drawn by the WebGL is encapsulated into a layer, the layer rendering data is acquired in the form of preset layer encapsulation format, and then the layer rendering data is mapped into the WebGL data format, so that the underlying drawing ability is opened to a web application layer.

In S101, the initial rendering information is acquired.

According to the embodiment of the application, in order to perform graphics rendering, the initial rendering information shall be acquired first. The initial rendering information may be acquired by any suitable way, which, for example, may be from a gallery, uploaded or input by an operator, etc.

As a preferred embodiment, the initial rendering information includes to-be-rendered element data and a linear transformation instruction to be performed on the to-be-rendered element. The to-be-rendered element data may be picture or image data in any format, and the linear transformation instruction includes instructions such as translation, rotation and scaling.

In S102, the initial rendering information is converted according to the preset layer encapsulation format to obtain the layer rendering data.

As a preferred embodiment, the preset layer encapsulation format includes a preset data source format and a preset matrix format. The layer rendering data includes pixel data of the to-be-rendered element and transformation matrix data of the to-be-rendered element. The operation of converting the initial rendering information according to the preset layer encapsulation format to obtain the layer rendering data includes that: the to-be-rendered element data is converted according to the preset data source format to obtain the pixel data; and the linear transformation instruction is converted according to the preset matrix format to obtain the transformation matrix data.

As a preferred embodiment, the operation of converting the linear transformation instruction according to the preset matrix format to obtain the transformation matrix data includes that: according to the linear transformation instruction and the corresponding preset matrix format, the linear transformation matrix corresponding to the linear transformation instruction is obtained, and then the initial matrix is multiplied by the corresponding linear transformation matrix in turn according to an order of the linear transformation instruction to obtain the transformation matrix data. The preset matrix format is preset according to the linear transformation instruction, and the same type of linear transformation instructions correspond to the same preset matrix format. The type of the linear transformation instruction includes any one of translation, rotation and scaling.

As a specific embodiment, the preset data source format and the preset matrix format are provided to the web application layer through corresponding interfaces. The to-be-rendered element data is converted by setting a texture pixel and/or directly setting a frame buffer to obtain the pixel data. The linear transformation instruction of the to-be-rendered element is converted according to the preset matrix format to obtain a 3×3 matrix, that is, the transformation matrix data. A texture pixel format is a way in which an image is stored in a Graphics Processing Unit (GPU) memory, and the way of setting the texture pixel may be any applicable way in a conventional art, which is not particularly limited here. Each storage unit of the frame buffer corresponds to one pixel, and the whole frame buffer corresponds to one image. The way of setting the frame buffer may adopt any applicable way in the conventional art, which is not particularly limited here.

In the specific embodiment, the preset matrix format is a 3×3 matrix, including an initial matrix format, a translation matrix format, a rotation matrix format and a scaling matrix format.

Diagonal elements in the initial matrix are all 1, and the other elements are 0. The initial matrix format is as follows:

$$[ \begin{matrix}1 & 0 & 0 \\ 0 & 1 & 0 \\ 0 & 0 & 1\end{matrix} ] ,$$

The translation matrix format is as follows:

$$[ \begin{matrix}1 & 0 & 0 \\ 0 & 1 & 0 \\ x & y & 1\end{matrix} ] ,$$

where x represents displacement in the horizontal direction (x-axis direction), and y represents the displacement in the vertical direction (y-axis direction). The unit of displacement is pixel point. The positive displacement of the x axis or y axis is represented by a positive number, and the negative displacement of the x axis or y axis is represented by a negative number.

The rotation matrix format is as follows:

$$[ \begin{matrix}cos α & - sin α & 0 \\ sin α & cos α & 0 \\ 0 & 0 & 1\end{matrix} ] ,$$

where α represents a clockwise rotation angle.

The scaling matrix format is as follows:

$$[ \begin{matrix}m & 0 & 0 \\ 0 & n & 0 \\ 0 & 0 & 1\end{matrix} ] ,$$

where m represents a scaling factor in the horizontal direction (x-axis direction), and n represents the scaling factor in the vertical direction (y-axis direction). For example, if the to-be-rendered element is reduced by half in both the horizontal and vertical directions, m=n=0.5.

The operation of converting the linear transformation instruction of the to-be-rendered element according to the preset matrix format includes that: a translation matrix, a rotation matrix and a scaling matrix are respectively obtained according to the linear transformation instruction such as translation, rotation and scaling of the to-be-rendered element, and then the initial matrix is multiplied by the translation matrix, rotation matrix and scaling matrix in the order of translation, rotation and scaling to obtain the transformation matrix data; and if a certain type of linear transformation instruction is not acquired, the matrix of the type is skipped.

In S103, the layer rendering data is mapped into the WebGL data format to obtain the WebGL rendering data.

As a preferred embodiment, the operation of mapping the layer rendering data into the WebGL data format to obtain the WebGL rendering data includes that: the pixel data is mapped into WebGL texture; and the transformation matrix data is mapped into an attribute in a WebGL shader.

As a preferred embodiment, the initial rendering information includes global attribute data. The method for graphics rendering based on the WebGL in the embodiment further includes that: before S102, WebGL context is set according to the global attribute data. The global attribute data includes data related to global attributes such as canvas width and height.

In S104, the WebGL interface is invoked and rendering output is performed according to the WebGL rendering data.

Specifically, a required rendering element is obtained by invoking the WebGL interface and performing graphics rendering according to the WebGL context, WebGL texture and attribute in the WebGL shader.

The above implementation of the application may be used to render a picture or an image, including rendering a single element or multiple elements in the picture or image. The to-be-rendered element is encapsulated into the layer, interfaces for setting a data source and linear transformation are provided to the web application layer, and the pixel data and transformation matrix data of the to-be-rendered element are acquired through corresponding interfaces. Furthermore, the pixel data and the transformation matrix data are mapped into the WebGL texture and the attribute in the WebGL shader respectively, and the WebGL interface is invoked for rendering, so that the underlying drawing ability is opened to the web application layer, and the understanding cost of the development of web application layer rendering is reduced without manually maintaining various attributes in the state machine, which is simple and easy to operate.

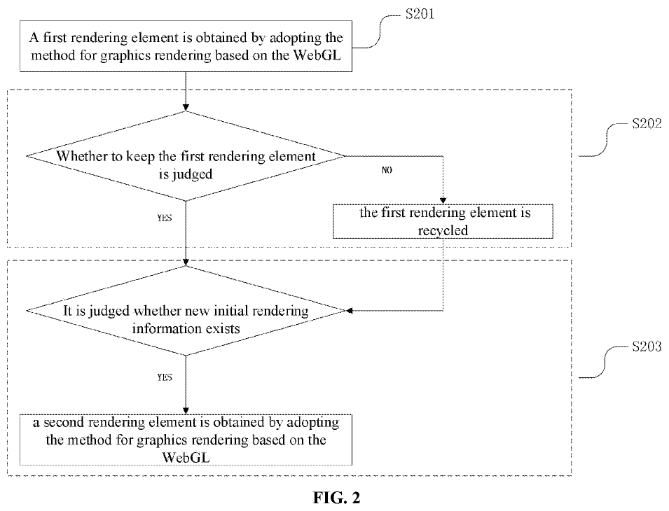

According to another implementation of the application, a method for graphics rendering based on a WebGL is provided. As shown in FIG. 2, the method includes that: at S201, a first rendering element is obtained by adopting the method for graphics rendering based on the WebGL; at S202, whether to keep the first rendering element is judged; if not, the first rendering element is recycled; and at S203, it is judged whether new initial rendering information exists; and if so, a second rendering element is obtained by adopting the method for graphics rendering based on the WebGL.

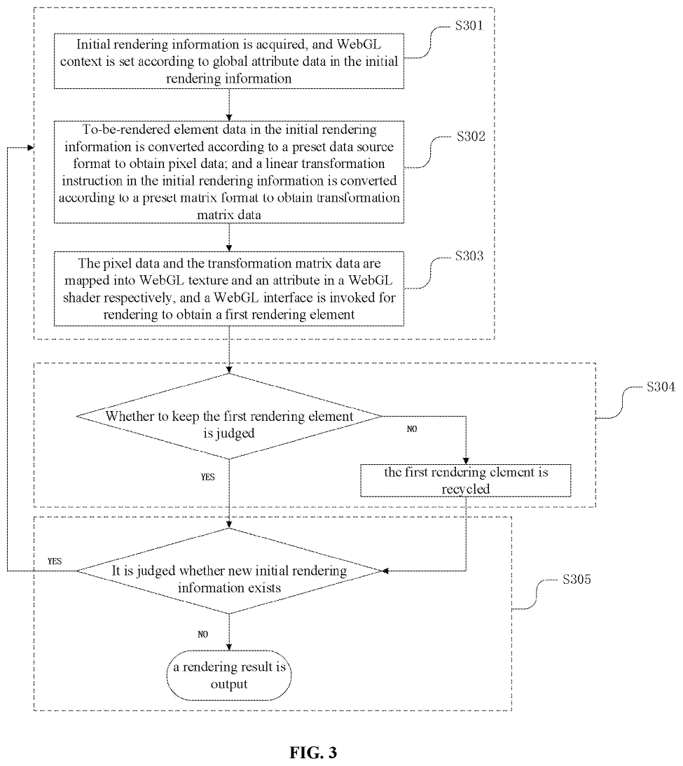

As a specific embodiment, as shown in FIG. 3, the method for graphics rendering based on the WebGL includes the following operations.

At S301, initial rendering information is acquired, and WebGL context is set according to global attribute data in the initial rendering information.

At S302, to-be-rendered element data in the initial rendering information is converted according to a preset data source format to obtain pixel data; and a linear transformation instruction in the initial rendering information is converted according to a preset matrix format to obtain transformation matrix data.

At S303, the pixel data and the transformation matrix data are mapped into WebGL texture and an attribute in a WebGL shader respectively, and a WebGL interface is invoked for rendering to obtain a first rendering element.

At S304, whether to keep the first rendering element is judged, and if not, the first rendering element is recycled.

At S305, it is judged whether new initial rendering information exists; if so, S301-S303 are repeated to obtain a second rendering element; and if not, a rendering result is output.

It may be understood by those skilled in the art that the sequence of “judging whether to keep the first rendering element” in S304 and “judging whether new initial rendering information exists” in S305 may be interchanged, which is not specifically limited here. It is to be noted that, according to the sequence of the above embodiment, whether to keep the first rendering element is judged by means of S304, if not, the first rendering element is recycled, storage space and a processing thread are released, and then whether new initial rendering information exists is judged by means of S305, so that the processing efficiency is higher.

The above implementation of the application may be used to render different to-be-rendered elements in multiple periods, and different periods may include different to-be-rendered elements. Effective management of multi-period element rendering may be implemented by the above method.

Another implementation of the application provides an apparatus for graphics rendering based on a WebGL. The apparatus is configured to execute the steps in the embodiment of the method for graphics rendering based on the WebGL described above in conjunction with FIG. 1.

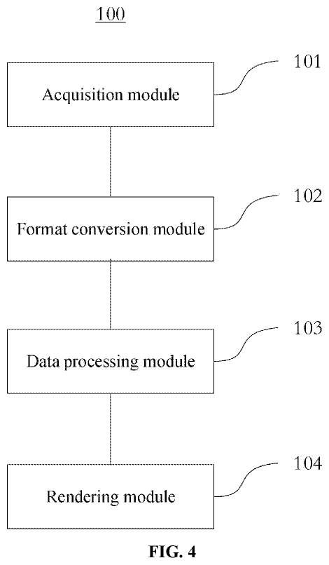

As shown in FIG. 4, the apparatus 100 includes an acquisition module 101, a format conversion module 102, a data processing module 103, and a rendering module 104. The acquisition module 101 is configured to acquire initial rendering information. The format conversion module 102 is configured to convert the initial rendering information according to a preset layer encapsulation format to obtain layer rendering data. The data processing module 103 is configured to map the layer rendering data into a WebGL data format to obtain WebGL rendering data. The rendering module 104 is configured to invoke a WebGL interface and perform rendering output according to the WebGL rendering data.

As a preferred embodiment, the acquisition module 101 is configured to acquire the following information: to-be-rendered element data and a linear transformation instruction to be performed on the to-be-rendered element. The preset layer encapsulation format includes a preset data source format and a preset matrix format. The layer rendering data includes pixel data of the to-be-rendered element and transformation matrix data of the to-be-rendered element. The format conversion module 102 is configured to obtain the layer rendering data in the following manner: the to-be-rendered element data is converted according to the preset data source format to obtain the pixel data; and the linear transformation instruction is converted according to the preset matrix format to obtain the transformation matrix data.

Preferably, the format conversion module is configured to acquire the pixel data in the following manner: the to-be-rendered element data is converted by setting a texture pixel and/or directly setting a frame buffer to obtain the pixel data. The format conversion module is configured to obtain the transformation matrix data in the following manner: according to the linear transformation instruction and the corresponding preset matrix format, the linear transformation matrix corresponding to the linear transformation instruction is obtained, and then the initial matrix is multiplied by the corresponding linear transformation matrix in turn according to an order of the linear transformation instruction to obtain the transformation matrix data.

As a specific embodiment, the format conversion module 102 includes a data processing unit, a data source interface, and a transformation matrix interface. The data processing unit is configured to perform data format conversion on the to-be-rendered element data and the linear transformation instruction such as translation, rotation and scaling to be performed on the to-be-rendered element acquired by the acquisition module 101 according to the preset data source format and the preset matrix format, respectively, to obtain the pixel data and transformation matrix data of the to-be-rendered element. The data source interface is connected to the data processing unit, and is configured to acquire the pixel data of the to-be-rendered element from the data processing unit. The transformation matrix interface is connected to the data processing unit, and is configured to acquire the transformation matrix data of the to-be-rendered element from the data processing unit.

As a preferred embodiment, the data processing module 103 is configured to obtain the WebGL rendering data in the following manner: the pixel data is mapped into WebGL texture; and the transformation matrix data is mapped into an attribute in a WebGL shader. Specifically, the data processing module 103 is respectively connected with the data source interface and the transformation matrix interface, and acquires the pixel data and transformation matrix data of the to-be-rendered element from the data source interface and the transformation matrix interface, which are mapped into the WebGL texture and the attribute in the WegGL shader respectively.

As a preferred embodiment, the initial rendering information further includes global attribute data. The apparatus for graphics rendering based on the WebGL in the embodiment further includes a setting module, configured to set WebGL context according to the global attribute data.

It is to be understood that, with regard to the apparatus for graphics rendering based on the WebGL in the implementation described above with reference to FIG. 4, the specific mode in which each module executes operations has been described in detail in the embodiment of the method for graphics rendering based on the WebGL described in conjunction with FIG. 1, and will not be explained in detail here.

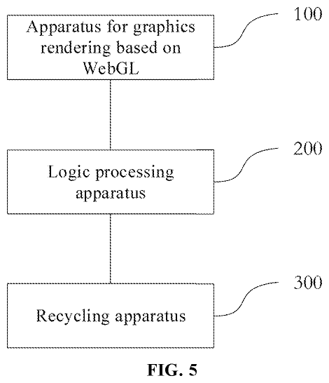

Another implementation of the application further provides a system for graphics rendering based on a WebGL. As shown in FIG. 5, the system includes the above-mentioned apparatus 100 for graphics rendering based on the WebGL, a logic processing apparatus 200 and a recycling apparatus 300. The apparatus 100 for graphics rendering based on the WebGL is configured to obtain a rendering element. The logic processing apparatus 200 is configured to process a logic judgment. The recycling apparatus 300 is configured to recycle the rendering element according to an instruction of the logic processing apparatus 200.

It is to be understood by those skilled in the art that the logic processing apparatus 200 may be used to process any necessary logic judgment related to process management of graphics rendering based on the WebGL, including but not limited to: after the first rendering element is obtained by the apparatus 100 for graphics rendering based on the WebGL, whether to keep a first rendering element is judged; if not, the recycling apparatus 300 is instructed to recycle the first rendering element; and/or it is judged whether new initial rendering information exists; and if so, the apparatus 100 for graphics rendering based on the WebGL is instructed to obtain a second rendering element according to the new initial rendering information.

It is to be understood that, with regard to the system for graphics rendering based on the WebGL in the implementation described above with reference to FIG. 5, the specific mode in which each apparatus executes operations has been described in detail in the embodiments of the method for graphics rendering based on the WebGL described in conjunction with FIGS. 1-3, and will not be explained in detail here.

Another implementation of the application further provides an electronic apparatus. The apparatus includes a memory and a processor. The memory stores a computer program. When executing the computer program, the processor implements the following steps: initial rendering information is acquired; the initial rendering information is converted according to a preset layer encapsulation format to obtain layer rendering data; the layer rendering data is mapped into a WebGL data format to obtain WebGL rendering data; and a WebGL interface is invoked and rendering output is performed according to the WebGL rendering data.

It is to be understood that the steps implemented when the processor executes the computer program are basically consistent with the implementation mode of each step in the above method. The specific mode has been described in detail in the embodiment of the method for graphics rendering based on the WebGL, and will not be described in detail here.

Another implementation of the application provides a computer readable storage medium. The storage medium stores a computer program. When executed, the computer program implements the following steps: initial rendering information is acquired; the initial rendering information is converted according to a preset layer encapsulation format to obtain layer rendering data; the layer rendering data is mapped into a WebGL data format to obtain WebGL rendering data; and a WebGL interface is invoked and rendering output is performed according to the WebGL rendering data.

It is to be understood that the steps implemented when the processor executes the computer program are basically consistent with the implementation mode of each step in the above method. The specific mode has been described in detail in the embodiment of the method for graphics rendering based on the WebGL, and will not be described in detail here.

The above embodiments of the application are introduced in detail. Specific cases are used in the disclosure to explain the principle and implementations of the application. The descriptions of the above embodiments are only for helping to understand the method and core idea of the application. Meanwhile, for those of ordinary skill in the art, there will be variations in the specific implementation and application scope according to the idea of the application. In conclusion, the content of the specification shall not be understood as a limitation to the application.

It is to be understood that claims and the specification of the application and terms “first”, “second”, etc. in the accompanying drawings are used for distinguishing different objects rather than describing a specific sequence. Terms “comprising” and “including” used in the specification and claims of the application indicate the presence of the described features, integers, steps, operations, elements and/or components, but do not exclude the presence or addition of one or more other features, integers, steps, operations, elements, components and/or groups thereof.

It is also to be understood that terms used in the specification of the application are only adopted to describe the purpose of the specific embodiments and not intended to limit the application. As used in the specification and claims of the application, unless the context clearly indicates otherwise, singular forms of “a”, “an” and “the” are intended to include plural forms. It is further to be understood that the term “and/or” used in the specification and claims of the application refers to any combination and all possible combinations of one or more of the items listed in association, and includes these combinations.

What is claimed is:

1. A method for graphics rendering based on a Web Graphics Library (WebGL), comprising:
acquiring initial rendering information;
converting the initial rendering information according to a preset layer encapsulation format to obtain layer rendering data;
mapping the layer rendering data into a WebGL data format to obtain WebGL rendering data; and
invoking a WebGL interface and performing rendering output according to the WebGL rendering data.

2. The method for graphics rendering based on the WebGL of claim 1, wherein the initial rendering information comprises to-be-rendered element data and a linear transformation instruction to be performed on the to-be-rendered element.

3. The method for graphics rendering based on the WebGL of claim 2, wherein the preset layer encapsulation format comprises a preset data source format and a preset matrix format, the layer rendering data comprising pixel data of the to-be-rendered element and transformation matrix data of the to-be-rendered element, wherein the step of converting the initial rendering information according to the preset layer encapsulation format to obtain the layer rendering data comprises:
converting the to-be-rendered element data according to the preset data source format to obtain the pixel data; and
converting the linear transformation instruction according to the preset matrix format to obtain the transformation matrix data.

4. The method for graphics rendering based on the WebGL of claim 3, wherein the step of converting the to-be-rendered element data according to the preset data source format to obtain the pixel data comprises:
converting the to-be-rendered element data by setting a texture pixel and/or directly setting a frame buffer to obtain the pixel data.

5. The method for graphics rendering based on the WebGL of claim 3, wherein the step of converting the linear transformation instruction according to the preset matrix format to obtain the transformation matrix data comprises:
obtaining, according to the linear transformation instruction and the corresponding preset matrix format, a linear transformation matrix corresponding to the linear transformation instruction, and then multiplying an initial matrix by the corresponding linear transformation matrix in turn according to an order of the linear transformation instruction to obtain the transformation matrix data.

6. The method for graphics rendering based on the WebGL of claim 5, wherein the preset matrix format is preset according to the linear transformation instruction, wherein a same type of linear transformation instructions correspond to a same preset matrix format.

7. The method for graphics rendering based on the WebGL of claim 3, wherein the step of mapping the layer rendering data into the WebGL data format to obtain the WebGL rendering data comprises:
mapping the pixel data into WebGL texture; and
mapping the transformation matrix data into an attribute in a WebGL shader.

8. The method for graphics rendering based on the WebGL of claim 1, wherein the initial rendering information comprises global attribute data, and the method further comprises:
setting, before converting the initial rendering information according to the preset layer encapsulation format to obtain the layer rendering data, WebGL context according to the global attribute data.

9. A method for graphics rendering based on a Web Graphics Library (WebGL), comprising:
obtaining a first rendering element by adopting the method for graphics rendering based on the WebGL of claim 1;
judging whether to keep the first rendering element; when the first rendering element is not kept, recycling the first rendering element;
judging whether new initial rendering information exists; and when the new initial rendering information exists, obtaining a second rendering element by adopting the method for graphics rendering based on the WebGL of claim 1.

10. An apparatus for graphics rendering based on a Web Graphics Library (WebGL), comprising:
an acquisition module, configured to acquire initial rendering information;
a format conversion module, configured to convert the initial rendering information according to a preset layer encapsulation format to obtain layer rendering data;
a data processing module, configured to map the layer rendering data into a WebGL data format to obtain WebGL rendering data; and
a rendering module, configured to invoke a WebGL interface and perform rendering output according to the WebGL rendering data.

11. The apparatus for graphics rendering based on the WebGL of claim 10, wherein the acquisition module is configured to acquire the following information: to-be-rendered element data and a linear transformation instruction to be performed on the to-be-rendered element.

12. The apparatus for graphics rendering based on the WebGL of claim 11, wherein the preset layer encapsulation format comprises a preset data source format and a preset matrix format, the layer rendering data comprising pixel data of the to-be-rendered element and transformation matrix data of the to-be-rendered element, wherein the format conversion module is configured to obtain the layer rendering data in the following manner:
converting the to-be-rendered element data according to the preset data source format to obtain the pixel data; and
converting the linear transformation instruction according to the preset matrix format to obtain the transformation matrix data.

13. The apparatus for graphics rendering based on the WebGL of claim 12, wherein the format conversion module is configured to obtain the pixel data in the following manner:
converting the to-be-rendered element data by setting a texture pixel and/or directly setting a frame buffer to obtain the pixel data.

14. The apparatus for graphics rendering based on the WebGL of claim 12, wherein the format conversion module is configured to obtain the transformation matrix data in the following manner:
obtaining, according to the linear transformation instruction and the corresponding preset matrix format, a linear transformation matrix corresponding to the linear transformation instruction, and then multiplying an initial matrix by the corresponding linear transformation matrix in turn according to an order of the linear transformation instruction to obtain the transformation matrix data.

15. The apparatus for graphics rendering based on the WebGL of claim 12, wherein the data processing module is configured to obtain the WebGL rendering data in the following manner:
mapping the pixel data into WebGL texture; and
mapping the transformation matrix data into an attribute in a WebGL shader.

16. The apparatus for graphics rendering based on the WebGL of claim 10, wherein the initial rendering information comprises global attribute data, and the apparatus further comprises:
a setting module, configured to set WebGL context according to the global attribute data.

17-20. (canceled)

21. The method for graphics rendering based on the WebGL of claim 4, wherein mapping the layer rendering data into a WebGL data format to obtain WebGL rendering data comprises:
mapping the pixel data into WebGL texture; and
mapping the transformation matrix data into an attribute in a WebGL shader.
